(19) United States
(12) Patent Application Publication
(10) Pub. No.: US 2018/0308032 A1
(43) Pub. Date: Oct. 25, 2018

(54) SYSTEM AND METHOD FOR DETERMINING IMPACT MEASUREMENT SCORES BASED UPON CONSUMER TRANSACTIONS

(71) Applicant: Aspiration Partners, Inc, Marina del Rey, CA (US)

(72) Inventors: Irfan Kamal, Los Angeles, CA (US); Lily Bowles, Los Angeles, CA (US); Andrei Cherny, Pheonix, AZ (US); Alexandra Horigan, Los Angeles, CA (US)

(73) Assignee: Aspiration Partners, Inc., Marina del Rey, CA (US)

(21) Appl. No.: 15/671,000

(22) Filed: Aug. 7, 2017

Related U.S. Application Data
(60) Provisional application No. 62/489,127, filed on Apr. 24, 2017.

(51) Int. Cl. G06Q 10/06

(52) U.S. Cl. CPC G06Q 10/06393

(57) ABSTRACT

A system and method are provided that present consumers with the means to assess the impact of their transactions upon environmental and societal concerns. The system determines impact measurement scores based upon consumer transactions. The impact Scores provides consumers with insight as to the impact of their transactions upon one or more areas of concern, e.g., environmental and societal. As such, consumers can more directly conform their purchasing habits to align to their environmental and societal concerns.

### CROSS REFERENCE TO RELATED APPLICATION

This application claims the benefit of U.S. App. No. 62/489,127, filed Apr. 24, 2017, which is incorporated by reference.

### FIELD OF THE INVENTION

The present invention relates generally to rating consumer transactions and, more particularly, to rating consumer transactions in terms of factors such as societal and environmental impact.

### BACKGROUND OF THE INVENTION

As a general matter, consumer transactions involve a provider and a consumer of a desired goods or service. Primary factors in purchasing decision typically include price, convenience, and quality of the desired good or service. Traditionally, these factors are readily available to consumers. As such, they tend to be the driving factors in determining whether to proceed with the transaction.

However, in the collective, such transactions can produce wide range of consequences, often unintended by the consumer and the provider. For example, to be competitive on the factors of price, convenience, and quality, businesses can be less attentive to other concerns, such as environmental impact and societal impact.

Environmental impact includes issues such as CO2 emission, renewable power usage, waste disposal, resource efficiency, recycling, just to name a few. Societal impact can include issues such as compliance with child labor laws, fair labor practices, healthcare coverage, compensation issues, and others.

Such environmental and societal concerns are important to many individuals. Individuals intending to affect change in these areas of concern typically do so through various channels such as political activism, charitable donations, volunteerism, or their profession. However, due in part to a lack of information, it can be challenging for individuals to align their everyday purchasing decisions with such concerns. Individuals that endeavor to conform their purchasing decisions to be in line with their societal and environmental values often require substantial investments of time and resources. As such, only very dedicated individuals, endowed with the necessary time and resources, can successfully conform their purchasing habits to their environmental and societal concerns.

It should, therefore, be appreciated that there exists a need for a system and method of providing consumers with the means to assess the impact of their transactions upon environmental and societal concerns. The present invention fulfils this need and others.

### SUMMARY OF THE INVENTION

Briefly, and in general terms, a computerized system provides consumers with impact scores reflecting the environmental and social impacts of companies where they have purchased goods or services. The system assigns impact score(s) to consumer transactions. The Impact Score(s) provides consumers with insight as to the impact of their transactions upon specific areas of concern, e.g., environmental and societal. As such, consumers can more directly conform their purchasing habits to align to their environmental and societal values. It is further envisioned such behavior modification will incentive businesses to improve their environmental and societal impacts as they are being directly communicated to their customers.

More specifically, in an exemplary embodiment, the system includes a database management system (DBMS) that maintains detailed data relating to consumer transactions and businesses. The system further includes modules for performing various tasks related to capturing, analyzing and presenting data, and results, including a transaction capture module, a business impact module, an consumer impact scoring module, and an interface module, which are discussed in detail below. The system gathers data from users and data sources, e.g., via a digital network, e.g., internet, to aid in populating the DBMS.

The system can be implemented in a variety of application without departing from the invention, so long as the system has the authorization to access the consumer's transaction data. In certain examples, consumers can consolidate or otherwise provide transaction data to the system. A consumer can also authorize the system to retrieve the transaction data from the consumer's financial providers, e.g., bank(s), credit card provider, or other financial services providers. In an exemplary embodiment, the system can be implemented by a bank that provides banking services to individuals. As such, the system would have access to transaction data for customer's checking and other accounts with the bank or financial service provider, and the consumer can further provide additional data from other financial service providers or authorize the system to access or otherwise receive such transaction data. In yet other embodiments, the system can be implemented via financial software products, which can reside on a consumer's device or accessed remotely.

For purposes of summarizing the invention and the advantages achieved over the prior art, certain advantages of the invention have been described herein. Of course, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

All of these embodiments are intended to be within the scope of the invention herein disclosed. These and other embodiments of the present invention will become readily apparent to those skilled in the art from the following detailed description of the preferred embodiments having reference to the attached figures, the invention not being limited to any particular preferred embodiment disclosed.

### BRIEF DESCRIPTION OF THE DRAWINGS

Embodiments of the present invention will now be described, by way of example only, with reference to the following drawings in which:

FIG. 1 is a simplified block diagram of a system in accordance with the invention.

FIG. 2 is a simplified block diagram of database management system (DBMS) of the system of FIG. 1.

FIG. 3 is an exemplary chart of determining an Impact Score in the People category for business in accordance with the system of FIG. 1, in this scenario the business has publicly disclosed information readily available.

FIG. 4 is an exemplary chart of determining an Impact Score in the People category for business in accordance with the system of FIG. 1, in this scenario; the business does not have publicly disclosed information readily available.

FIG. 5 is an exemplary chart of determining an Impact Score in the Planet category for business in accordance with the system of FIG. 1, in this scenario the business has publicly disclosed information readily available.

FIG. 6 is an exemplary chart of determining an Impact Score in the Planet category for business in accordance with the system of FIG. 1; in this scenario, the business does not have publicly disclosed information readily available.

FIG. 7 is a screenshot of a system application on a client device in accordance with the system of FIG. 1, depicting a summary screen.

FIG. 8 is a screenshot of a system application on a client device in accordance with the system of FIG. 1, depicting impact scores information and corresponding transactions for a given month.

FIG. 9 is a screenshot of a system application on a client device in accordance with the system of FIG. 1, depicting a chart and list of historical impact scores over several months, arrived at by selecting “History” on the screenshot of FIG. 8.

FIG. 10 is a screenshot of a system application on a client device in accordance with the system of FIG. 1, depicting impact assessment of a specific business (selected from the listing on FIG. 8) and corresponding transactions of the client within a prescribed time frame.

FIG. 11 is a screenshot of a system application on a client device in accordance with the system of FIG. 1, arrived at by selecting “View similar businesses” on the screenshot of FIG. 10.

FIG. 12 is a screenshot of a system application on a client device in accordance with the system of FIG. 1, depicting information relating a specific transaction from the screenshot of FIG. 10.

FIG. 13 is a screenshot of a system application on a client device in accordance with the system of FIG. 1, depicting information relating a specific transaction from the screenshot of FIG. 8, in which the system lack impact score(s) for the merchant.

FIG. 14 is a screenshot of a system application on a client device in accordance with the system of FIG. 1, depicting means for corresponding with the merchant of FIG. 13, to request that the merchant obtains impact score(s).

### DETAILED DESCRIPTION OF THE PREFERRED EMBODIMENTS

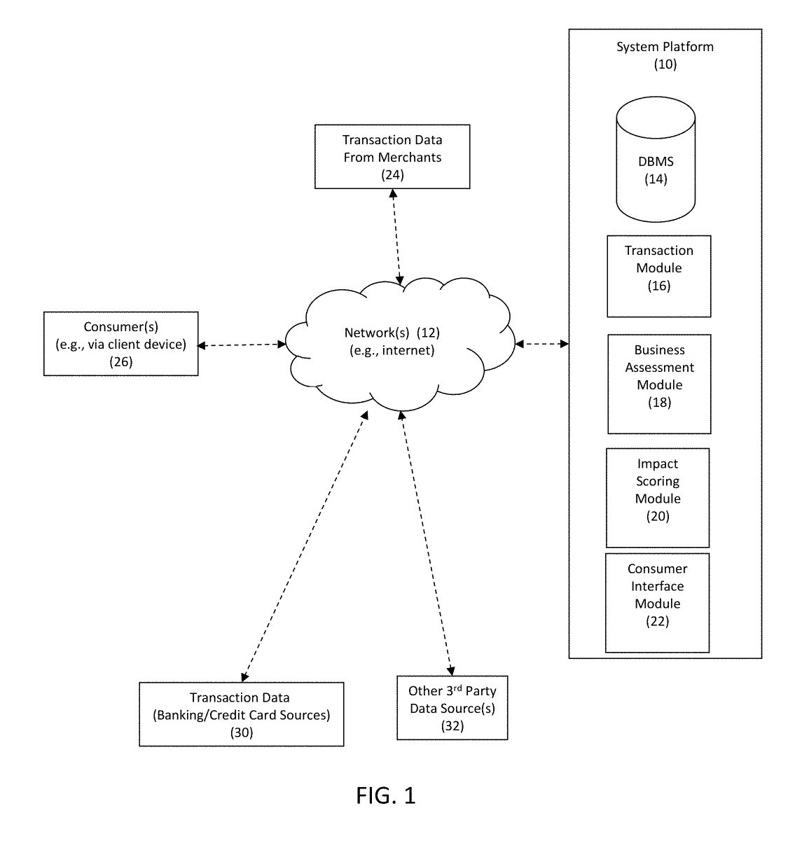

Referring now to the drawings, and particularly FIG. 1, there is shown a computerized system 10 that provides consumers with the means to assess the impact of their transactions upon environmental and societal concerns. The system 10 determines impact measurement score(s) based upon consumer transactions. The impact score(s) provides consumers 26 with insight as to the impact of their transactions upon one or more areas of concern, e.g., environmental and societal. As such, consumers can more directly conform their purchasing habits to align to their environmental and societal concerns. It is further envisioned such behavior modification will incentive businesses to minimize adverse environmental and societal impacts.

With continued reference to FIG. 1, the system 10 includes a database management system (DBMS) 14 that maintains detailed data relating to consumer transactions and businesses. The system 10 further includes modules for performing various tasks related to capturing, analyzing and presenting data, and results, including a transaction capture module 16, a business impact module 18, an impact scoring module 20, and an interface module 22, which are discussed in detail below. The system 10 gathers data from users 26 and data sources, e.g., via a digital network 12, e.g., internet, to aid in populating the DBMS 14.

The system can be implemented in a variety of applications without departing from the invention, so long as the system has the authorization to access the consumer's transaction data. In certain examples, consumers can consolidate or otherwise provide transaction data to the system. Consumers can also authorize the system to retrieve the transaction data from their financial providers, e.g., bank(s), credit card provider, or other financial services providers. In an exemplary embodiment, the system 10 can be implemented within by a bank that provides banking services to individuals. As such, the system would have access could to transaction data for customer's checking and other accounts with the bank, and Consumers can further provide additional data from other financial service providers or authorize the system to access or otherwise receive such transaction data. In yet other embodiments, the system can be implemented via financial software products, which can reside on a consumer's device or accessed remotely.

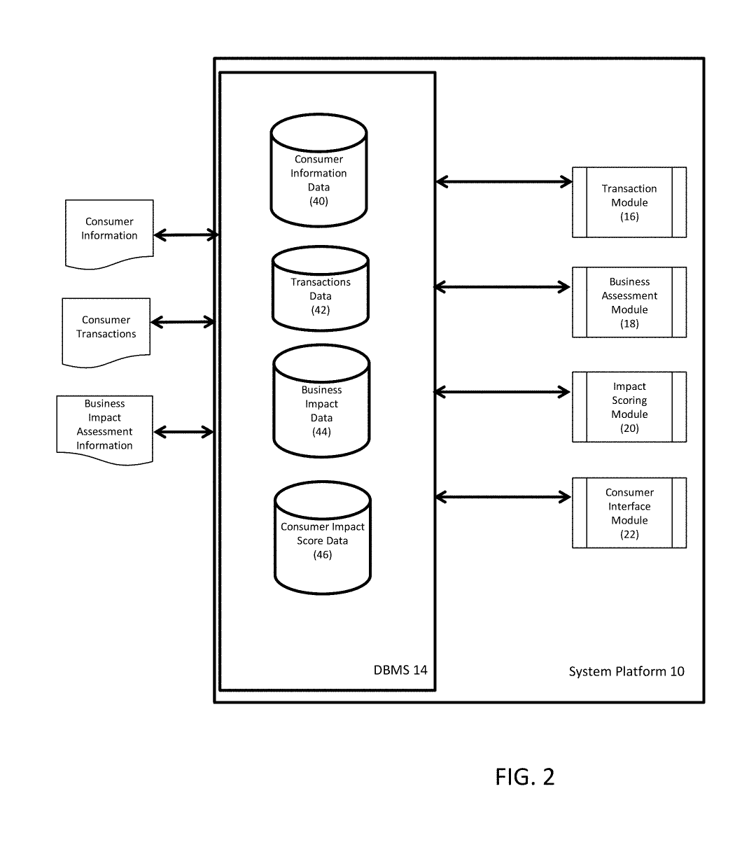

With reference now to FIG. 2, there is shown a simplified block diagram of database management system (DBMS) 14 of the system. The DBMS maintains detailed data relating to consumers 40, transactions 42, business impact 44, and consumer impact data 46.

It will be appreciated that data of the DBMS can be combined into different database configurations in other embodiments of this invention. Additional information regarding these databases will be discussed throughout this description. The data stored on the data storage assembly can be read, written, and executed by the various components, servers and modules included in the system.

### Consumer Data

Consumer data 40 includes information such as name, address, contact information, financial history, impact history, access authorization, etc. It can further include information relating to consumers' environmental and societal concerns of choice, so that the system can tailor impact scores and or reports to consumers concerns. Data can be provided by a variety of sources, e.g., consumer 26, third-party data sources 32, or financial institutions 24, 30.

### Transaction Data

Transaction data 42 typically includes information such as the date, time, purchase price, and merchant details, among others. In certain instances, it can also include an itemized listing of all items or services purchase via the transaction. The system 10 can receive transaction data 42 from various sources, e.g., merchants, financial institutions, consumers, consolidated via financial software programs, or other third party providers, among others. In certain examples, consumers can consolidate or otherwise provide transaction data to the system. As such, transaction data received by the system 10 can be provided in various formats. The transaction module 16 can be configured to analyze the received transaction data and conform for use by the system. From input transaction data, the system extracts such elements and brand, location, company, time/day, merchant/acquirer. This data can then be used for identifying and calculating brand/merchant/consumer scores.

### Business Impact Data

Business Impact data 44 includes impact rankings in societal and environmental areas of concern. The concerns can be broadly categorized, as “People” and “Planet.” The People category would account the impact of the business on societal issues. The “Planet” category would account for the impact of the business on environmental issues.

Third party providers (e.g., 32, FIG. 1) of data can be utilized by system to aid in populating business impact data 44. Such third party data and providers can include, e.g., HIP™ rankings available from HIP Investor, Inc., of San Francisco, Calif., Thomson Reuters, Corp., Glassdoor, Inc., Fortune® magazine rankings, Forbes Media LLC, and others. In addition, data ranking can be internally generated based upon investigation or publically available information from other third party sources (32), such as government databases, business disclosures, and others. The impact data can include assigning metric value to factors that comprise the broad categories of concern.

The People and the Planet categories can include for a number of factors and/or metrics that can be assigned values, e.g., such as combinations of the following:

| “People” Factors/Metrics | “Planet” Factors/Metrics |
|---|---|
| Legal Judgments | Energy Efficiency |
| Lobbying | Resource Efficiency |
| Board Diversity | GHG Emissions |
| Decision Making | Waste Production |
| Metrics | Water Usage |
| CEO Comp to Employee Comp | Carbon Reductions |
| Employee Access to Stock | Renewable Power Usage |
| Options | Supplier Sourcing - Environmental |
| | Impact |
| Employee Pay | Third Party Certifications - environment |
| Job Safety | Env. Atmosphere |
| Access to Healthcare | Env. Land |
| Supplier Sourcing - Social | Env. Water |
| Impact | |
| Women Employees | Sust. Energy Use & Production |
| Women Managers | Supply Chain |
| Employee Satisfaction | |
| Employee Retention | |
| Workplace Ranking(s) | |
| Third Party Certifications - | |
| workforce related | |
| Customer Satisfaction | |
| Customer Guarantees | |
| Community Development | |
| Investment | |
| Anti-Competitive Behavior | |
| Business Model | |
| Corporate Governance | |
| Data Security & Privacy | |
| Human Capital | |
| Marketing Practices | |
| Political Influence | |
| Product Integrity & Innovation | |
| Social Impact | |

In an exemplary embodiment, impact scores are determined for companies including their subsidiaries. Scoring can be determined for subsidiaries and/or brands based on their own corporate data. Thus, brands with the same parent company could receive different scores, as the data would be coming from the subsidiary level instead of parent company level.

A business is assigned valuation in one or more of the metrics within each category. For convenience of reference, companies, businesses, and brands are referred to in a general manner to identify the provider of goods/services received by a consumer in a transaction. Moreover, the businesses that operate one or more subsidiaries or brands can be correlated so that metrics can be assigned. For example, Berkshire Hathaway owns several consumer brands, e.g., Dairy Queen, GEICO, etc. These relationships can be accounted for by the system to aid in collecting metric information; since publically traded companies are obligated to disclose information, (e.g. in 10-K forms). For example, in a purchase at Dairy Queen, the transaction data would typically list Dairy Queen as the provider; however, business impact data for Dairy Queen can be populated or supplemented by metric information from or of its parent company. In addition, companies or subsidiaries can provide detailed company information to the system so that they can be assigned a more accurate score.

The system can variably weight the various metrics within each category to achieve an Impact Score for each category (e.g., People, Planet) as well as a consolidated score (e.g., both People and Planet).

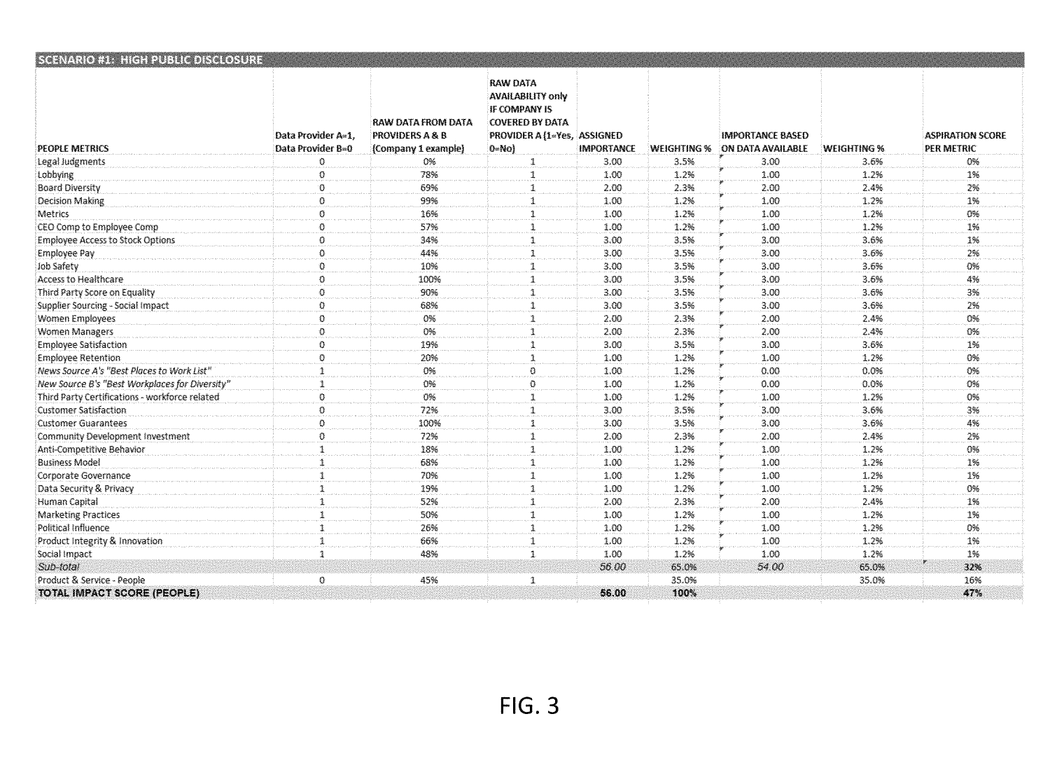

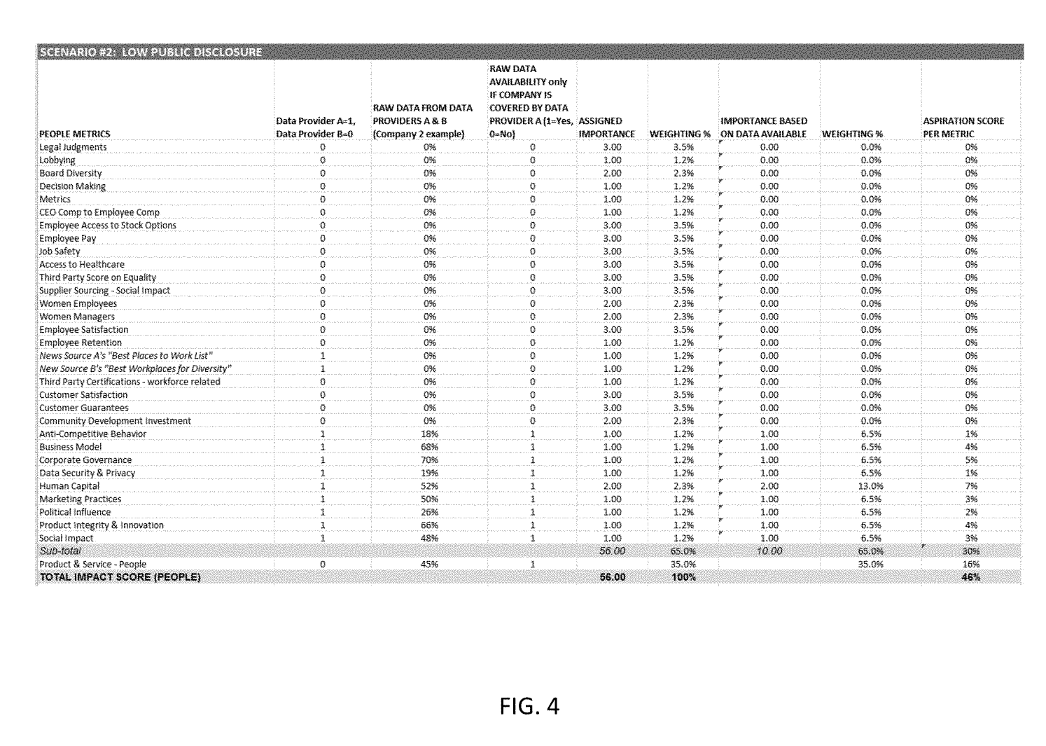

With reference now to FIGS. 3-6, businesses are assigned a value for each metric, if available. For example, FIGS. 3 and 4 depict a determination of an Impact Score in the “People” category. FIG. 3 depicts an example where public information is readily available for a business. FIG. 4 depicts an example where public information is not readily available for a business.

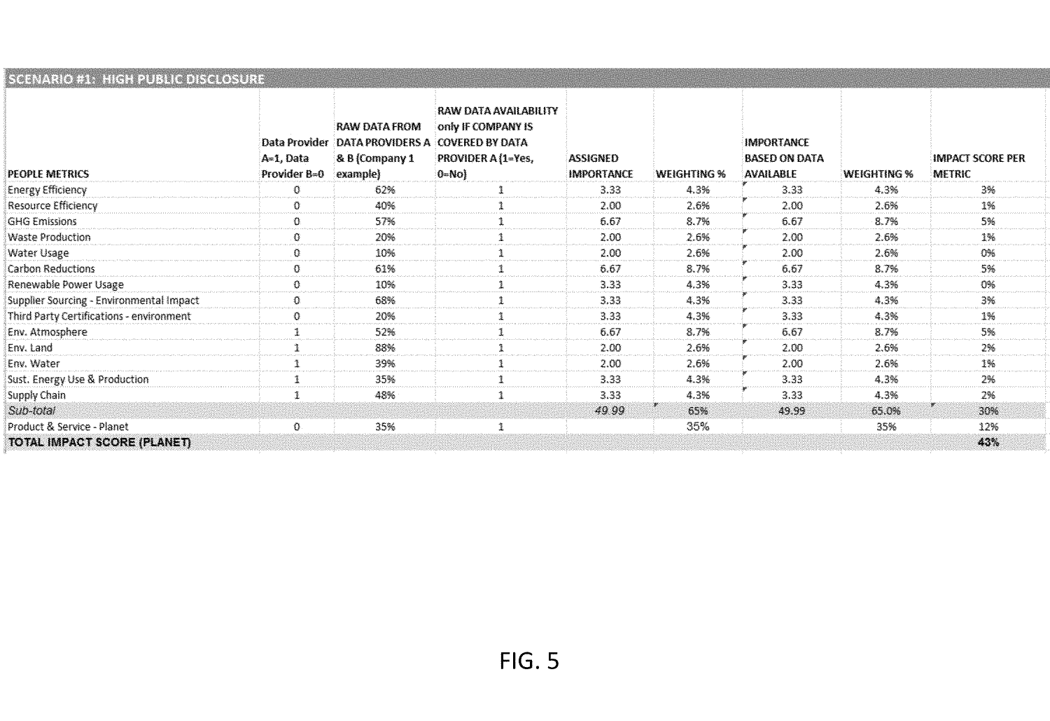

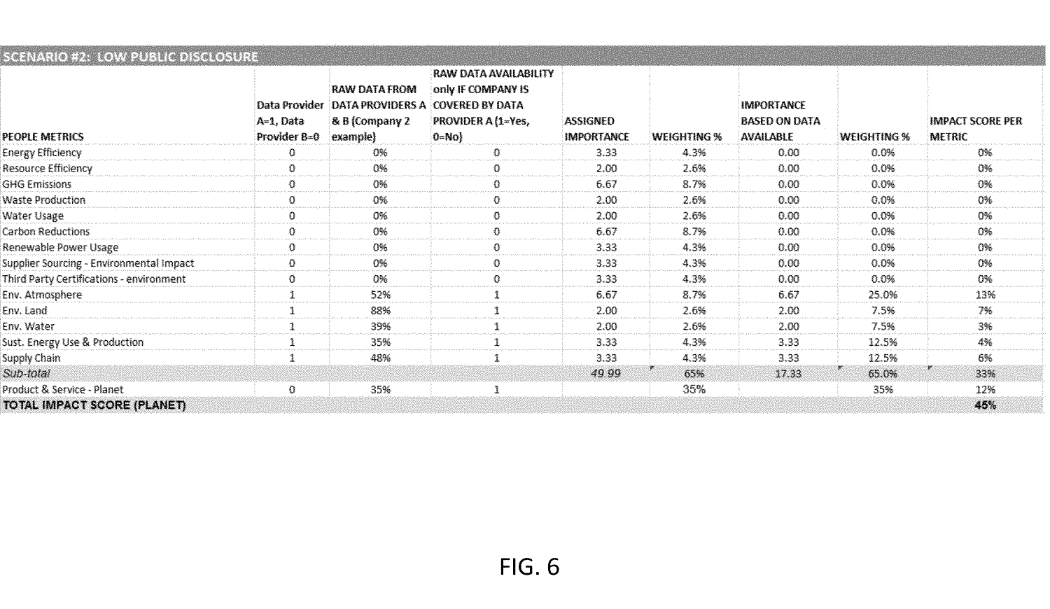

For example, FIGS. 5 and 6 depict a determination of an Impact Score in the Planet category FIG. 5 depicts an example where public information is readily available for a business. FIG. 6 depicts an example where public information is not readily available for a business.

In the exemplary embodiment, each metric is assigned a percentage ranking that represents the business's performance on that particular metric. Each metric is weighted by relative importance to each other. With the weighting applied, a total Impact Score is determined for the category.

### Consumer Impact Scores

Consumer Impact scoring data 46 relates impact scores assigned to consumer based upon the consumer's transaction data. The impact scoring module 20 assesses the consumer transaction data 42, to identify the corresponding business merchants identified with the transactions. The module determines and applies rules to map the transactions to a corresponding brand/business. The impact score for the corresponding brand/business is retrieved. The scoring module 20 utilizes transaction characteristics (such as amount, frequency, time/date, category, company, brand, etc.) to determine a weighted, individual category score for an individual based on the brand associated with each transaction. Impact scores can be calculated based upon one or more of the transaction characteristics. An impact score can be determined based upon one of the transaction characteristics. Below is an example of calculating impact scores based on spending, e.g., as follows:

$$Consumer Impact {Score}_{( cat . )} = \frac{[ \begin{matrix}( {Brand}_{( a )} Impact {Score}_{( cat . )} \times Amount Spent ) + \\ ( {Brand}_{( b )} Impact {Score}_{( cat . )} \times Amount Spent ) + … \\ ( {Brand}_{( n )} Impact {Score}_{( People )} \times Amount Spent )\end{matrix} ]}{Total Spent ( {Brand}_{( a , ) … } {Brand}_{( n )} )}$$

A composite score is determined for the consumer by compiling each Impact category score times a weighting factor, as follows:

Consumer Impact (Impact Score_{(cat 1)}×Weight Factor_{(Cat 1.)})+(Impact Score_{(cat. 2)}×Score_{(composite)}=Weight Factor_{(Cat. 2)})+ . . . (Impact Score_{(Cat. N)}×Weight Factor_{(Cat. N)})

Weight factors are assigned by the system. In the above example, the transaction characteristic, Amount Spent, can be replaced with another transaction characteristic, e.g., frequency, to determine an impact score. It is also contemplated that impact scores can be determined using formula(s) that consider more than one transaction characteristic.

The resulting consumer impact score 46 are maintained in the DBMS 14. The consumer interface module 22 can present resulting reports to the consumer based upon historical consumer impact scores. The reports can detail trends over time to aid the consumer in tracking and modifying purchasing habits to align to their environmental and societal concerns. In addition, reports that consolidate trends across a plurality of consumers can be generated to assess if and how sharing corporate ESG performance through transaction data affects: (1) consumer spending, and (2) incentivizes corporations to improve their environmental and social practices.

In certain embodiments, the system provides scores for brand merchants where customers shop (i.e. the store or online marketplace that shows up as a line in their transaction data). When data is available on the item level, the system can provide scores for brands at the item level that people buy in from stores, whether brick-and-mortar or online.

For example, if a customer buys Dove soap (parent company Unilever) on Jet.com (parent company Amazon) or at Ralphs (parent company Kroger), if the transaction data lacks an itemized listing of purchased goods, the system would show the customer Jet.com or Ralphs in the transaction data, and give the scores for Amazon or Kroger, respectively. If itemized listing is provided in the transaction data, the system provide impact scoring based upon the item(s), e.g., Dove (parent company Unilever).

Connections between components are shown using double-sided arrows, which may be physical, fiber optic, wireless, or any other type of communications link over a network. The network can be any of a variety of conventional network topologies and types (including optical, wired and/or wireless networks), using a variety of conventional network protocols (including public and/or proprietary protocols). The network can include, for example, home networks, cellular networks, corporate networks, Intranet(s), or the Internet, as well as possibly at least portions of one or more local area networks (LANs) and/or wide area networks (WANs) or telephone networks, among others.

The client devices that may be any of a variety of digital devices, including, for example, and not limitation, a desktop PC, a notebook or portable computer, a workstation, an Internet appliance, a handheld PC, a cellular telephone or other wireless communications device, a personal digital assistant (PDA), a set-top box, or combinations thereof. Other hardware components capable of digitally communicating and interacting with the system can be used without departing from the invention.

The system 10 can incorporate a database management system (DBMS) 14 configured to store system information in digital format utilizing hardware known in the art, such as hard drive, random access memory, read only memory, flash memory, cache memory, a portable magnetic computer diskette, such as a floppy diskette, zip disk, and/or other configurations capable of storing programming, data, or other digital information on hardware devices, whether co-located or distributed across a network. The term “database management system (DBMS)” is inclusive of one or more database systems. Moreover, other hardware components capable of digitally communicating and interacting with the system can be used without departing from the invention.

The system 10 is arranged to process data, control data access and storage, issue commands, and control other desired operations, including the various modules individually and collectively (e.g., 16, 18, 20, and 22). The system includes a processor assembly (16, 18, 20, and 22) having processing circuitry configured to implement desired programming. For example, processing circuitry (hardware) may be implemented as one or more of a processor and/or other structure configured to execute executable instructions including, for example, software and/or firmware instructions, and/or hardware circuitry. Exemplary embodiments of processing circuitry include hardware logic, state machines, and/or other structures alone or in combination with a processor. Storage circuitry is configured to store programming such as executable code or instructions (e.g., software and/or firmware), electronic data, databases, or other digital information and may include processor-usable media. Processor-usable media may be embodied in any computer program, product(s), or article of manufacture(s) that can contain, store, or maintain programming, data, and/or digital information for use by or in connection with an instruction execution system including processing circuitry in the exemplary embodiment. System capabilities (including processing, data processing, data storage, module features, and others) of the system can be co-located or distributed across a network (including internet) without departing from the invention.

It will be understood that when components, apparatus, appliance, functions, steps or elements of this invention need to be or may be implemented on a data processing apparatus as a whole, or any individual component thereof described herein, that the apparatus or any individual component as described herein may be utilized within the contemplation of this invention. For instance, if a flowchart as described herein expressly or implicitly requires for example that a processor or storage for example be utilized, the applicable components described herein may be so utilized even if not specifically recited for that step.

With reference now to FIGS. 7-14, exemplary screenshots are depicted for a consumer interface on a client device 26 that enables the user to interact with the system related to the user's account. The data is accessed from the DBMS (14), including consumer information (40), transaction data (42), business impact data (44), and consumer impact data (46). The interface can be provided my any means known in the art, e.g., such as internet browser, system application, software application, among others. The interface enables the user to access transaction history, user's impact scores, relevant business impact scores, and so on.

FIG. 7 depicts a screenshot of a summary screen, which provides a summary account information, including deposits, withdrawals, interest earning, an account balance, and the consumer's impact score for the most recent time period, (e.g., month to date, last 30 days, or other time period). The user can interact with the summary screen to access additional information via selection of an item on the screen. For example, the summary screen includes selectable icons, for snapshot, activity, deposits, transfers, and payment. The selection of one of the aforementioned icons will provide the user with the corresponding information.

FIG. 8 depicts a screenshot providing detailed information on the user (consumer) impact score and corresponding transactions for given time, e.g., current month. The impact score include an overall impact score (70) and category specific impact scores for “people” (74) and to “planet” (76). The provided scores are calculated via the impact scoring module 20, as discussed above. Transactions summaries over the given time are also provided, which totals transactions at a particular business within the given time. Each transaction summary lists the business, transaction amount, and impact scores for the business. For example, the transaction summary (80) details that the user spent $39.14 in the given month, and it further indicates that Oscars Groceries Stores has “People” impact score of 83 in a “Planet” impact score of 89.

FIG. 9 depicts a screenshot that provides a chart (90) and a list (92) of historical impact scores over several months, for the user (consumer). This impact score history can provide the user's overall impact score (shown) over the prescribed time, as well as, category specific impact scores such as “People” and “Planet” (not shown). The chart 90 provides a graphical representation of the impact scores on a monthly basis for a rolling 12-month period. To the user can scroll through the timeline by selecting the arrow icons above the chart.

FIG. 10 depicts a screenshot that provides impact assessment of a specific business selected from the transaction summaries selected from the listing on FIG. 8 and corresponding transactions of the client within a prescribed period. More particularly in the exemplary embodiment, the present screenshot provides information relating to the transaction summary (80) for her Oscars Grocery Store for the prescribed time. Category specific impact scores for “People” and “Planet” are provided. Individual transactions by the consumer at a selected business are also listed herewith. The system also enables the user to identify similar businesses to the selected business for comparison of impact scores by selecting the term “view similar businesses.”

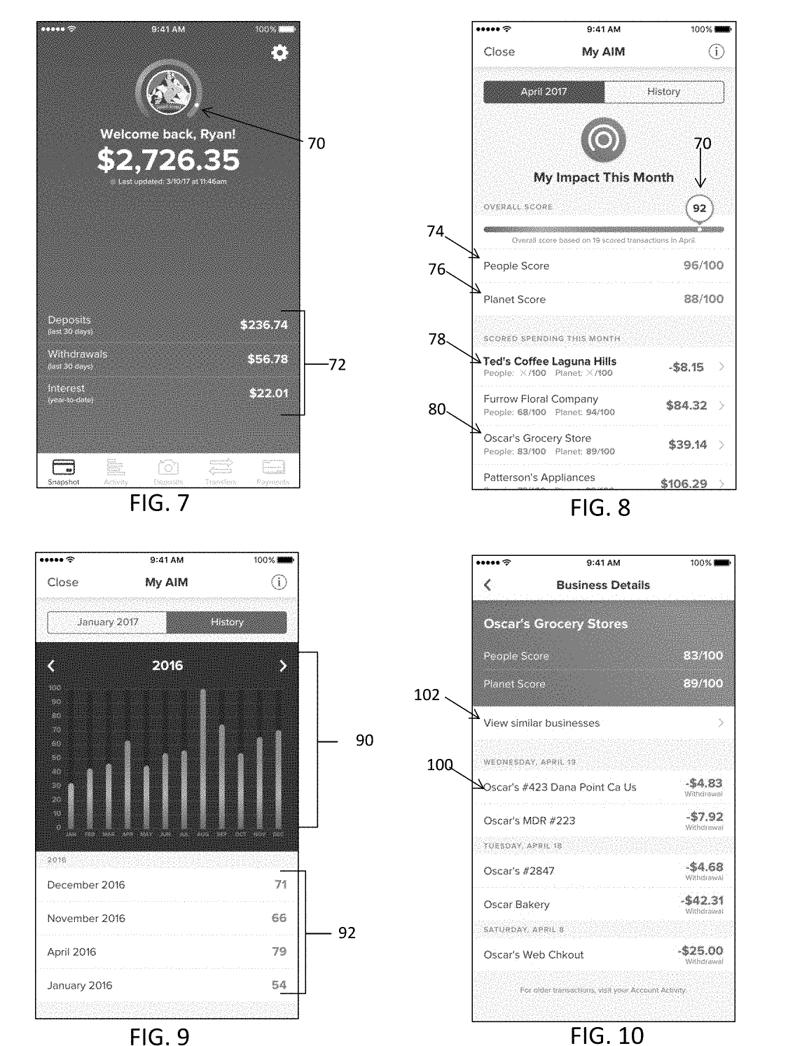

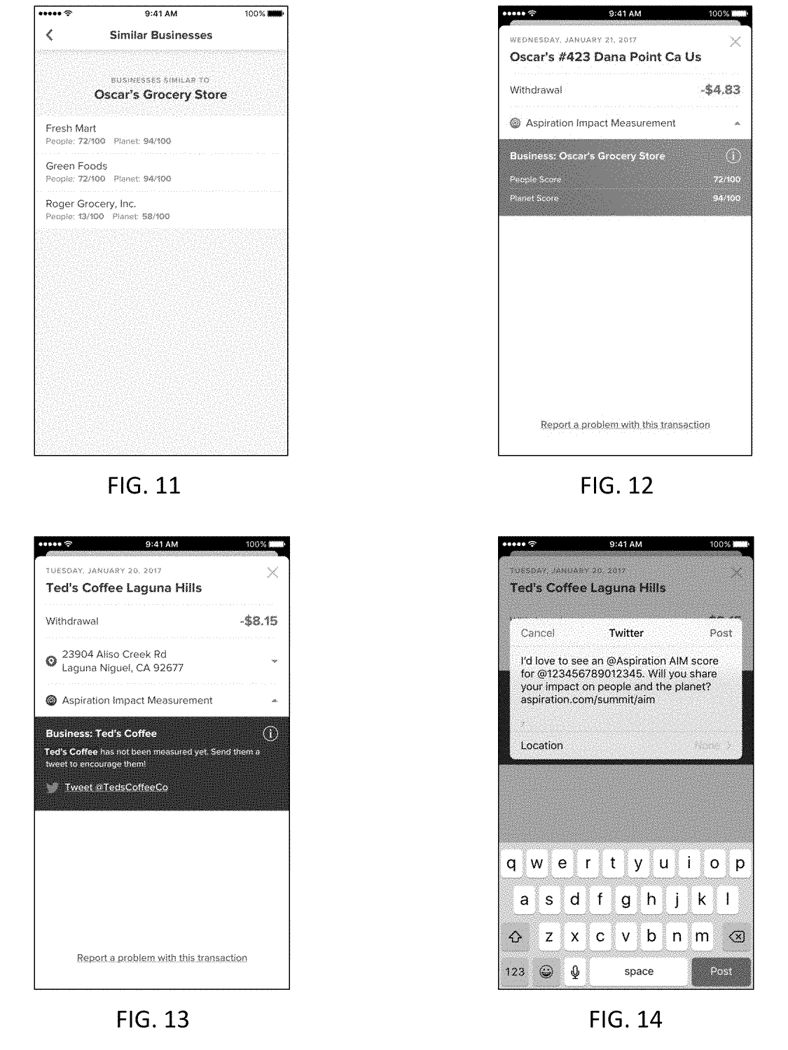

FIG. 11 depicts a screenshot arrived at by selecting “View similar businesses” (102). In this manner, the user can compare impact scores of similar businesses, providing to like goods and/or services. This enables the user to improve their impact score by modifying their purchase decisions. In the present example, Oscars Grocery Store is compared to three other businesses. Each corresponding business is listed with its corresponding impact scores. The data is accessed from the DBMS (14), including business impact data (44).

FIG. 12 depicts a screenshot depicting detailed information relating a specific transaction, i.e., transaction 100 (FIG. 10). The provided information includes transaction amount ($4.83), merchant name (Oscars), and merchant impact scores (People Score 72/100, Planet Score 94/100), which is accessed from the DBMS (14), including transaction data (42) and business impact data (44). In this example, the system includes an impact score for the merchant.

With reference now to FIGS. 13 and 14, the screenshots depict detailed information relating a specific transaction, i.e., transaction 78 (FIG. 8). The provided information includes transaction amount ($8.15) and merchant name (Ted's Coffee). In this example, the system lacks an impact score for the merchant; however, the user can use the system to correspond with the merchant of FIG. 13, to request that the merchant obtains impact score(s). In this example, the request is sent via a social network post (e.g., Twitter®), however, other communication means can be used without departing from the invention.

As will be appreciated by those of reasonable skill in the art, there are numerous embodiments to this invention, and variations of elements, steps and system components that may be used, all within the scope of this invention.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

It should be appreciated from the foregoing that the present invention provides a computerized system that presents consumers with the means to assess the impact of their transactions upon environmental and societal concerns. The system determines impact measurement score(s) based upon consumer transactions. The Impact Score(s) provides consumers with insight as to the impact of their transactions upon one or more areas of concern, e.g., environmental and societal. As such, consumers can more directly conform their purchasing habits to align to their environmental and societal concerns. It is further envisioned such behavior modification will incentive businesses to minimize adverse environmental and societal impacts.

The present invention has been described above in terms of presently preferred embodiments so that an understanding of the present invention can be conveyed. However, there are other embodiments not specifically described herein for which the present invention is applicable. Therefore, the present invention should not to be seen as limited to the forms shown, which is to be considered illustrative rather than restrictive.

What is claimed is:

1. A computerized method for determining impact measurement scores based upon consumer transactions, comprising:
accessing, at a network-based system, a database management system (DBMS) that maintains consumer data, consumer transaction data, business impact data having values assigned to a plurality of metrics corresponding impact rankings for societal concerns or environmental concerns, and/or consumer impact data;
transmitting impact scores of a business from the system to a client device in network communication with the system, in which the system determines the impact scores for the business via an impact scoring module of the network-based system, the impact scoring module (a) utilizes the plurality of metrics assigned to the business for societal concerns to calculate a societal impact score, (b) utilizes the plurality of metrics assigned to the business for environmental concerns to calculate an environmental impact score, wherein the matching module assigns a value to matching parameters based upon a prescribed range, and (c) calculates an overall impact score for the business based upon the societal impact score and/or the environmental impact score;
determining impact scores of a consumer from the system to a client device in network communication with the system, in which the system determines the impact scores for the consumer based upon (a) transaction data of the consumer and (b) impact scores of businesses within the transaction data of the consumer; and.
transmitting the impact scores of the business to the client device.

2. The method as defined in claim 1, wherein within the DBMS, the consumer data includes name, address, contact information, financial history, impact history, access authorization; and
the transaction data includes date, time, purchase price, and business name.

3. The method as defined in claim 1, wherein the impact scores of the consumer are determined via the impact scoring module of the system.

4. The method as defined in claim 3, wherein the impact scoring module (a) retrieves the consumer transaction data from the DBMS, (b) identifies a corresponding business for each transaction, (c) retrieves the impact scores for the corresponding businesses from the DBMS, (d) calculates an impact score for the consumer based upon the impact scores for the corresponding businesses and transaction amounts.

5. The method as defined in claim 1, wherein within the DBMS, the plurality of metrics assigned to the business for environmental concerns, include values associated with energy efficiency, resource efficiency, and emissions.

6. The method as defined in claim 1, wherein within the DBMS, the plurality of metrics assigned to the business for societal concerns, include employee compensation, healthcare, employee satisfaction, employee retention, and corporate governance.

7. The method as defined in claim 1, wherein the transaction data relates solely to transactions conducted through a bank account.

8. The method as defined in claim 1, wherein the transaction data is consolidated from a plurality of financial providers.

9. The method as defined in claim 1, wherein the provided impact scores comprising including the environmental impact score, the societal impact score, and the overall impact score.

10. The method as defined in claim 1, further comprising:
determining impact scores of a consumer from the system to a client device in network communication with the system, in which the system determines the impact scores for the consumer based upon (a) transaction data of the consumer and (b) impact scores of businesses within the transaction data of the consumer; and
transmitting the impact scores of the consumer to the client device.

11. A networked-based system for determining impact measurement scores based upon consumer transactions, the system comprising:
a database management system (DBMS) that maintains consumer data, consumer transaction data, business impact data having values assigned to a plurality of metrics corresponding impact rankings for societal concerns and environmental concerns, and consumer impact data; and
an impact scoring module in digital communication with the DBMS, the impact scoring module:
determines the impact scores for the business by (a) utilizing the plurality of metrics assigned to the business for societal concerns to calculate a societal impact score, (b) utilizing the plurality of metrics assigned to the business for environmental concerns to calculate an environmental impact score, wherein the matching module assigns a value to matching parameters based upon a prescribed trade range, and (c) calculating an overall impact score for the business based upon the societal impact score and the environmental impact score, the provided impact scores comprising including the environmental impact score, the societal impact score, and the overall impact score, and
determines impact scores of a consumer based upon (a) transaction data of the consumer and (b) impact scores of businesses within the transaction data of the consumer.

12. The system as defined in claim 11, wherein within the DBMS, the consumer data includes name, address, contact information, financial history, impact history, access authorization; and the transaction data includes date, time, purchase price, and business name.

13. The system as defined in claim 11, wherein the impact scores of the consumer are determined via the impact scoring module of the system.

14. The method as defined in claim 14, wherein the impact scoring module (a) retrieves the consumer transaction data from the DBMS, (b) identifies a corresponding business for each transaction, (c) retrieves the impact scores for the corresponding businesses from the DBMS, (d) calculates an impact score for the consumer based upon the impact scores for the corresponding businesses and transaction amounts.

15. The method as defined in claim 11, wherein within the DBMS, the plurality of metrics assigned to the business for environmental concerns, include values associated with energy efficiency, resource efficiency, and emissions.

16. The method as defined in claim 11, wherein within the DBMS, the plurality of metrics assigned to the business for societal concerns, include employee compensation, healthcare, employee satisfaction, employee retention, and corporate governance.

17. The method as defined in claim 11, wherein the transaction data relates solely to transactions conducted through a bank account.

18. The method as defined in claim 11, wherein the transaction data is consolidated from a plurality of financial providers.
